(19) United States
(12) Patent Application Publication
(10) Pub. No.: US 2002/0198474 A1
(43) Pub. Date: Dec. 26, 2002

(54) Method and apparatus for graft enhancement and skin therapy

(76) Inventor: Hilton Becker, Boca Raton, FL (US)

Correspondence Address: DOUGHERTY & TROXELL, SUITE 1404, 5205 LEESBURG PIKE, FALLS CHURCH, VA, 22041, US

(21) Appl. No.: 09/887,429

(22) Filed: Jun. 25, 2001

(51) Int. Cl. A61H 7/00

(52) U.S. Cl. 601/6

(57) ABSTRACT

A method for grating fat cells from one part of a patient's body to another includes the steps of inserting harvested fat cells under the skin at a selected site and subjecting the graft area to a reduced pressure. The externally applied reduced pressure is then pulsated at a frequency of between about 70 cycles per minute and 1 cycle per 5 minute interval. A heart rate monitor may be provided and the frequency of the pulsated reduced pressure is matched to a patient's heartbeat. A method for stretching skin and apparatus for drawing fluids from adjacent tissue into a mass of implanted fat cells is also disclosed.

### FIELD OF THE INVENTION

This invention relates to a method and apparatus for skin and tissue expansion and graft enhancement and more particularly to a method and apparatus for filling voids in a patient's skin by grafting fat cells from one part of a patient's body to another and for stretching skin before and/or after surgery.

### BACKGROUND FOR THE INVENTION

The effect of suction on blood circulation when the suction is exerted locally on the human body has been recognized for many years. Applicators for pneumatic therapy are also known. For example, the U.S. Pat. No. 3,841,322 of Spelio discloses a method for facial and neck tissue re-establishment which includes the application of cyclic suction-relaxation manipulative action to the tissue to improve lymphatic and venous circulation. Apparatus for practicing this method includes a variable pulsating vacuum device to transmit rhythmic suction-relaxation manipulative action to applicators in contact with the facial and neck tissue.

A more recent approach to applying a vacuum to areas of a human body is disclosed in the U.S. Pat. No. 5,897,512 of Zagame. As disclosed therein, a massage appliance includes a generally bell-shaped hollow body with an internal partition defining two mutually isolated compartments. Both compartments are connected to a pump which generates different degrees of suction in each of the compartments. A wave effect is obtained to provide a palpitating-and-rolling action.

Negative pressure devices have also been applied to wound closure therapy. For example, negative pressure has been used with a dressing to remove fluids from the wound and stimulate the growth of healthy granulation tissue as disclosed in the U.S. Pat. Nos. 5,636,643 and 5,645,081 of Argenta et al.

It is also well known that skin can be grafted from one area of a patient's body to another. The grafted skin initially survives on tissue fluid diffusing into the cells. Then, a new blood supply grows in and the heart pumps plasma into the cells. However, for many years, plastic surgeons have attempted to graft fat cells from one part of a patient's body to another part of the patient. Invariably, the grafts do not survive.

In other cases, plastic surgeons have stretched human skin, as for example, in breast reconstruction and augmentation. Current techniques of tissue expansion rely on placing a balloon type device under the skin and filling the expander to an arbitrary volume to exert tension to the skin. The tension must be less than the arterial blood pressure to ensure that the blood supply is not cut off to the tissues. Therefore, only small amounts of pressure can be used and slowly increased, usually at weekly intervals until the desired amount of expansion is obtained. African tribes used this technique with external devices to stretch their ears and lips.

It is presently believed that the methods and apparatus disclosed herein will enable plastic surgeons to graft fat cells from one part of a patient's body to another and to stretch a patient's skin more effectively. For example, pressures above arterial pressure can be applied to tissues for short periods of time with no ill effects, approximately 5 minutes.

Therefore, by using a device that can apply greater pressure to the tissues for intermittent periods and then relax in order to allow the blood to re-circulate, it is possible to expand the skin more rapidly and to a greater degree, without causing death to the tissues due to interruption of the blood supply.

### BRIEF SUMMARY OF THE INVENTION

In essence, the present invention contemplates a method for grafting fat cells from one part of a patient's body to a second or remote area of the body. The method includes the step of selecting a receptive site such as a void in the patient's skin. After selecting a receptive site, the area around the site including the area over the void is subjected to an externally applied reduced pressure until the patient's skin is stretched a predetermined amount. A donor site on the skin of a patient at an area remote from the receptive site is then selected and a puncture is made at the donor site. After making a puncture as for example by a needle, a mass of fat cells are harvested or withdrawn and the needle removed. The mass of fat cells is then injected into the void at the receptive site below the stretched skin and the needle is withdrawn. Fluid is then drawn into the mass of fat cells by subjecting the receptive site to externally applied reduced pressure. In a preferred embodiment of the invention the reduced pressure is pulsated at between about 70 cycles per minute to about 1 cycle per 5 minute interval. The pulsating reduced pressure is continued for a preselected period of time or until new blood vessels have been established and are sufficient to nourish the graft.

A second embodiment of the invention contemplate an improved method for stretching the skin of a human patient after a surgical procedure which produces a wound area. The improved method includes the step of selecting an area of a patient's skin, i.e., a wound area for stretching. A pressure cuff is provided and placed over the selected area. Then, the selected area is subjected to an externally applied reduced pressure by means of the pressure cuff. This reduced pressure is pulsated between periods of a reduced pressure and periods of relaxation until the skin has stretched a predetermined amount. In one preferred embodiment of the invention, the reduced pressure is pulsated at a frequency of between about 70 cycles per minute to about 1 cycle per 5 minute interval. The period for maintaining the reduced pressure treatment may range from one or more hours to several days.

A third embodiment of the invention comprises an apparatus for drawing fluids from adjacent tissue into a mass of transplanted fat cells. The apparatus includes a variable pulsating vacuum device which produces a rhythmic action of reduced pressure and relaxation. The apparatus also includes means such as computer activated valve for pulsating the rhythmic action between a frequency of about 70 cycles per minute or less. In addition, the apparatus includes concave means such as a cuff for applying the pulsating vacuum to an external area of a patient's body such as an area surrounding a transplanted mass of fat cells. Further, the apparatus includes means such as vacuum hose or tube for operatively connecting the concave means to the variable pulsating vacuum device. In a preferred embodiment of the invention, a monitor is provided for monitoring the patient's heartbeat and for regulating the pulsating rhythm to that of the patient's heartbeat.

The invention will now be described in connection with the accompanying drawings.

### DESCRIPTION OF THE DRAWING

FIG. 1 is a flow chart illustrating the steps in a first embodiment of the invention;

FIG. 2 is a flow chart illustrating a preferred embodiment of the invention;

FIG. 3 is a schematic illustration of a graft site which includes a mass of inserted fat cells before the formation of blood vessels to nourish the graft;

FIG. 4 is a schematic illustration of the graft site shown in FIG. 2 but including an externally applied vacuum cuff and showing the formation of new blood vessels for nourishing the graft; and,

FIG. 5 is a schematic illustration of an apparatus in accordance with a third embodiment of the invention.

### DETAILED DESCRIPTION OF THE PREFERRED EMBODIMENTS OF THE INVENTION

Autologous fat transplantation has been unpredictable due to the lack of survival of or cellular damage to the fat cells which may occur during harvesting as recognized in the U.S. Pat. No. 5,817,090 of Abergel et al. Invariably, such grafts do not survive. A further reason for the failure of such grafts is that a new blood supply is not established rapidly enough to allow the fat cells to survive. Other tissue, e.g. skin can be more readily grafted from one area to another. The grafted skin initially survives merely on tissue fluid fusing into the cells. Then as a new blood supply grows in, the pulsating flow of blood generated by the heart pumps plasma into the area.

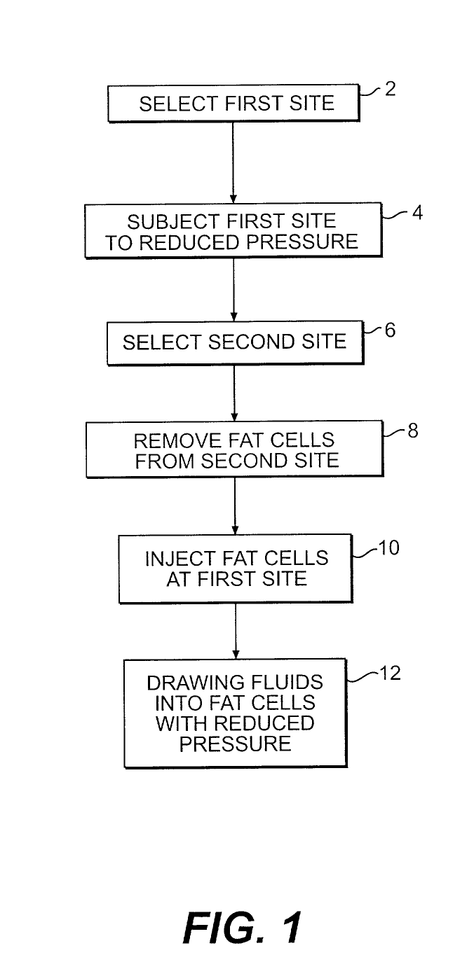

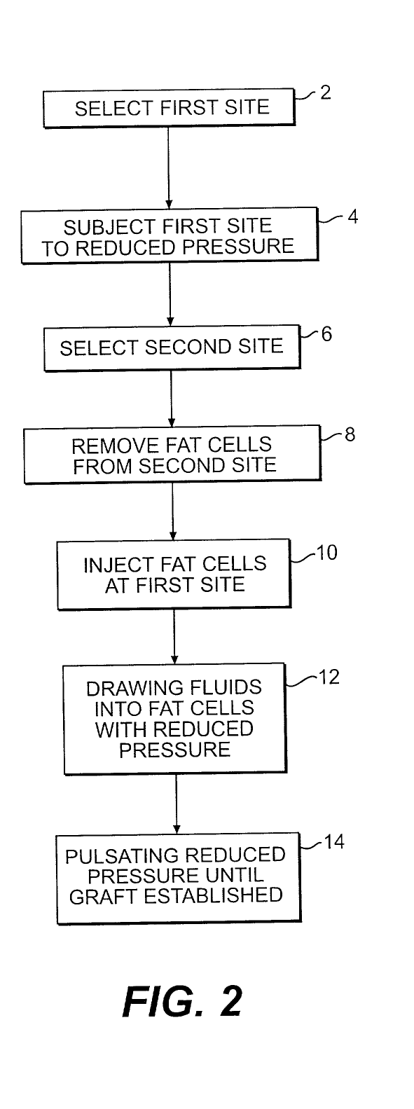

An improved method for autologous fat transplantation according to the preferred embodiment of the present invention will now be described in connection with FIGS. 1 and 2 and in connection with a surgical procedure for filling a void in a patient's skin as, as for example in the correction of acne scar depressions.

In the correction of acne scar depressions in accordance with the present invention, a surgeon selects a first site (step 2) for receiving an injection of fat cells and inspects the depression and the area surrounding the depression to determine that it is susceptible to surgical correction. The surgeon then subjects the area surrounding the depression and over the depression to a reduce pressure as indicated by step 4 in FIGS. 1 and 2. This reduced pressure may be applied by a conventional vacuum apparatus such as the apparatus illustrated in the aforementioned U.S. Pat. No. 3,841,322 of Spelio which is incorporated herein in its entirety by reference.

However, it is anticipated that a small portable vacuum device will be used and the reduced pressure may be applied for a period of one hour or more and may continue for up to several days. In one preferred embodiment of the invention this reduced pressure will be pulsated. For example, the period of reduced pressure may be interrupted with periods of relaxation with a cycle of between 70 cycles per minute to about one cycle per five minute interval.

The reduced pressure, constant or pulsed, is continued until the skin has been stretched a sufficient amount as determined by the surgeon for the purposes of the procedure. After the skin has been stretched, the surgeon selects a donor site in step 6. The donor site is selected from an area that is remote from the void or depression which is to be filled.

The donor site is cleaned in a conventional manner, as for example with an alcohol swab and the site punctured with a needle with a syringe attached. Then in step 8 fat cells from the second selected site are harvested, as for example by being drawn into the syringe. The puncture may then be covered with a gauze pad or the like.

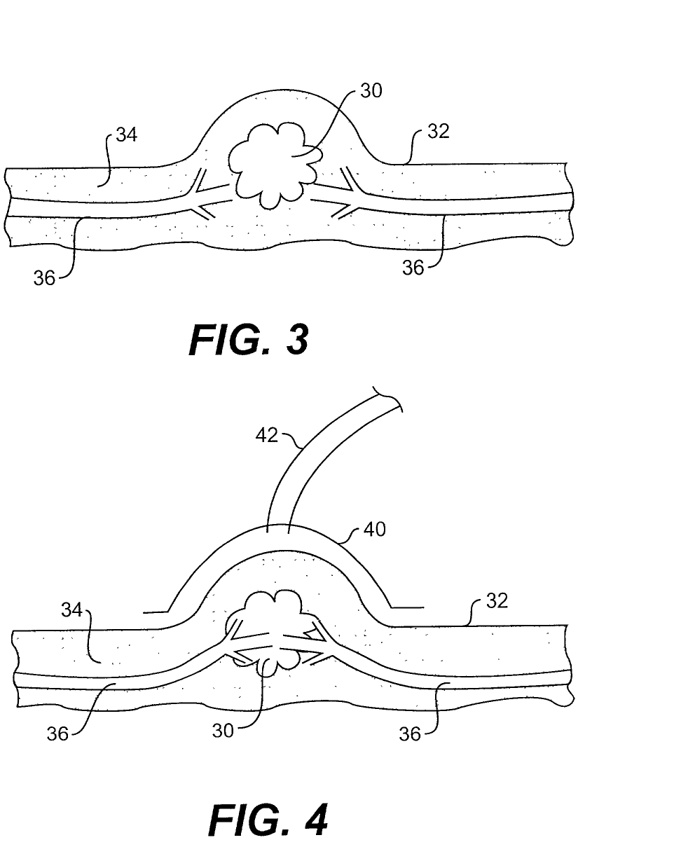

The first site that is the area around the depression is cleaned in a conventional manner and the fat cells are injected under the stretched skin in step 10. The amount of fat cells will be slightly larger then the depression to be filled as illustrated in FIG. 3. After injection of the fat cells, the needle is removed and the puncture wound allowed to close.

Then in step 12 the area surrounding the injected fat cells is subjected to a reduced pressure to draw fluids into the fat cells and the reduced pressure is maintained until new blood vessels attach and take over. Depending on the patient and the amount of fat cells injected, this reduced pressure may be continued over a period of several days.

In FIGS. 3 and 4 a mass of injected fat cells 30 are shown schematically under the skin 32 of a patient. As illustrated, the fat cells 30 are initially surrounded by tissue fluids 34 but are not connected to the blood vessels 36. In FIG. 4, a vacuum cuff 40 is positioned over the former depression on the patient's skin after the fat cell transplantation. The cuff 40 is attached to a vacuum hose 42 and to a source of reduced pressure such as a vacuum pump (not shown). The vacuum draws fluid into the graft nurturing the cells until new blood vessels are formed and take over. As shown in FIG. 4, the blood vessels 36 are attached to the mass of fat cells, so that, the fat cells are nourished and survive. At this point, a reduced pressure is no longer needed.

In a preferred embodiment of the invention as shown in FIG. 2, the method for autologous fat transplantation includes the step 14 of pulsating the reduced pressure until the graft is established. The alternating suction and relaxation cycles preferably range from about 70 cycles per minute to about one cycle per five minute interval.

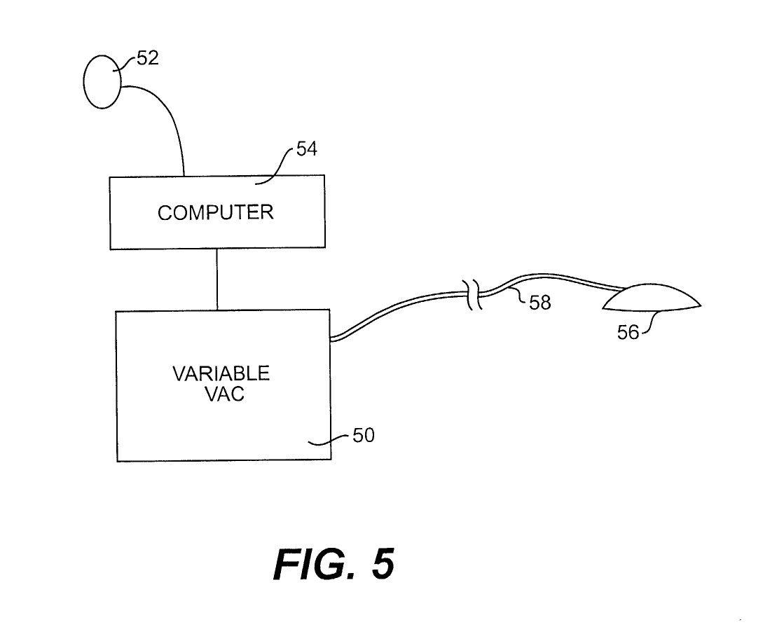

FIG. 5 is a schematic illustration of a portable device for use in practicing the methods in accordance with the present invention. As shown therein, the device includes a portable variable pulsating vacuum device which produces the rhythmic action of between about 70 cycles per minute to about one cycle per five minute interval. The device also includes a computer 54 and sensor 52 for monitoring the heart rate of a patient. The computer then varies the pulsating vacuum to match the heart rate of the patient. The rhythmic action is then delivered to a selected site on the patient by a vacuum cuff 56 by means of a vacuum hose 58.

It is presently believed that the vacuum provided should be within the range of about 150 millibars or hectopascals (hPa) to about 600 hPa. The pump may also be fitted with a sequencer or timer to enable the practitioner to program the cycles or to provide different pressures to be applied at different times or for different patients. A conventional sequencer or timer may be used as for example Chronomix interval timer such as those produced and sold by Chronomix Corp. of Sunnyvale, Calif.

It is also contemplated that the present method and apparatus disclosed herein may be used in the construction of a nipple during a breast reconstruction or in other surgical procedures where it is desired to stretch a patient's skin.

While the invention has been described in connection with the preferred embodiments it should be recognized that changes and modifications may be made therein without departing from the scope of the claims.

What is claimed is:

1. A method for grafting fat cells from a first portion of a human patient's body to a second part of the body comprising the steps of:
a) selecting a receptive site on the skin of a patient's body and identifying an area surrounding the receptive site;
b) subjecting the area surrounding the receptive site and including the receptive site to an externally applied reduced pressure until the patient's skin is stretched a predetermined amount;
c) selecting a donor site on the skin of the patient at an area remote from the receptive site;
d) making a puncture at the donor site and removing a mass of fat cells from the donor site of the patient's body;
e) inserting the mass of fat cells under the patient's skin at the receptive site; and
f) drawing body fluids into the mass of fat cells by subjecting the closed wound area to a reduced pressure.

2. A method for grafting fat cells from a first part of human patient's body to a second part of the body according to claim 1 which includes the step of pulsating the reduced pressure in step f at a frequency of between about 70 cycles per minute to about 1 cycle per 5 minute interval.

3. A method for grafting fat cells from a first part of a human patient's body to a second part of the body according to claim 2 which includes the step of monitoring the patient's heartbeat and matching the frequency of the pulsating reduced pressure to the frequency of the heartbeat.

4. A method for grafting fat cells from a first part of a human patient's body to a second part of the body according to claim 2 which includes the step of subjecting the closed wound area to the pulsating reduced pressure until new blood vessels extend into the mass of fat cells.

5. A method for stretching the skin of a human patient after a surgical procedure which produces a wound area, said method comprising the steps of:
selecting an area of a patient's skin in a wound area for stretching;
subjecting the selected area of skin to a reduced pressure; and
pulsating the reduced pressure between periods of reduced pressure and periods of relaxation until the skin has stretched a predetermined amount.

6. A method for stretching the skin of a human patient after a surgical procedure which produces a wound area according to claim 5 which includes the step of pulsating the reduced pressure at a frequency of between about 70 cycles per minute to about 1 cycle per 5 minute period.

7. A method for stretching the skin of a human patient after a surgical procedure which produces a wound area according to claim 5 wherein said wound area is a breast and in which said pulsating reduced pressure forms a nipple on the breast.

8. An apparatus for drawing fluids into a mass of transplanted fat cells comprising:
a variable pulsating vacuum device which produces a rhythmic action of reduced pressure and relaxation, means for regulating the pulsating rhythmic action between a frequency of about 50 to about 80 cycles per minute;
concave means for applying the pulsating vacuum to an external area of a patient's body surrounding a transplanted mass of fat cells and means for operatively connecting said concave means to said variable pulsating vacuum device,
means for monitoring the heart rate of the patient and means for matching the frequency of the pulsating rhythmic action to that of the heart rate.

9. An apparatus for drawing fluids into a mass of transplanted fat cells according to claim 8 in which said means for monitoring the heart rate of the patient and means for matching the frequency of the pulsating rhythmic action to that of the heart includes a computer.

10. An apparatus for drawing fluids into a mass of transplanted fat cells according to claim 9 in which the apparatus includes a pressure cuff for applying the pulsating vacuum to an external area of a patient's body.

11. A method for grafting fat cells from a first portion of a human patient's body to a second part of the body comprising the steps of:
a) selecting a receptive site on the skin of a patient's body and identifying an area surrounding the receptive site;
b) selecting a donor site on the skin of the patient at an area remote from the receptive site;
c) making a puncture at the donor site and removing a mass of fat cells from the donor site of the patient's body;
d) inserting the mass of fat cells under the patient's skin at the receptive site; and
e) drawing body fluids into the mass of fat cells by subjecting the closed wound area to a reduced pressure.
